(19) United States
(12) Patent Application Publication
(10) Pub. No.: US 2024/0199168 A1
(43) Pub. Date: Jun. 20, 2024

(54) BICYCLE HUB, SYSTEM, BICYCLE AND METHOD FOR MOUNTING A BICYCLE HUB

(71) Applicant: Porsche eBike Performance GmbH, Ottobrunn (DE)

(72) Inventors: Klaus Drost, Ottobrunn (DE); Matthias Leininger, Ottobrunn (DE); Maximilian Winkel, Ottobrunn (DE)

(21) Appl. No.: 18/537,218

(22) Filed: Dec. 12, 2023

(30) Foreign Application Priority Data
Dec. 15, 2022 (DE) 102022133475.9

(51) Int. Cl. B62M 6/60; B60L 50/20; B62M 6/80

(52) U.S. Cl. CPC B62M 6/60; B60L 50/20; B62M 6/80; B60L 2200/12

(57) ABSTRACT

In an embodiment a bicycle hub includes a hub element, a hub housing, an interface, and an electrical component electrically connected to the interface, wherein the hub housing is mounted rotatably relative to the hub element about a rotational axis in order to rotate together with a wheel of a bicycle, wherein the interface is arranged on an outer side of the bicycle hub and is rigidly connected to the hub element, wherein the interface is offset radially outwards relative to the rotational axis, and wherein the interface is configured for an electrical and mechanical coupling of the bicycle hub to a coupling element such that an electrical connection from the coupling element to the electrical component is established via the coupling and relative rotation between the hub element and the coupling element is blocked via the coupling.

### CROSS-REFERENCE TO RELATED APPLICATIONS

This application claims the priority of German Application No. 102022133475.9, filed on Dec. 15, 2022, which application is hereby incorporated herein by reference.

### TECHNICAL FIELD

A bicycle hub is specified. In addition, a system, a bicycle and a method for mounting a bicycle hub are specified.

### BACKGROUND

Bicycles are a cost-effective, easy-to-use and emission-free means of transportation. They have also become popular as sports and fitness equipment, and particularly suitable types have emerged for different areas of use.

In recent years, there has been a growing enthusiasm for electric bicycles, especially so-called “pedelecs”, despite their high weight and price for bicycles. Potential customers are not only older, less fit cyclists or those with no sporting ambitions, but also sporty, younger riders, whether for use on the way to work or because of the possibility of using them to extend their range of action and/or increase their travel speed without overstressing their own physique. Interest in electrically assisted mountain bikes seems to be growing among mountain bikers in particular.

### SUMMARY

Embodiments provide an improved bicycle hub, for example, a bicycle hub which is particularly easy to mount and/or which is particularly robust. Further embodiments provide a system with such a bicycle hub, a bicycle with such a bicycle hub and a method for mounting such a bicycle hub.

A first embodiment provides a bicycle hub. The bicycle hub is, for example, a rear wheel bicycle hub. In particular, the bicycle hub can be a rear wheel hub drive.

In at least one embodiment, the bicycle hub has a hub element, a hub housing, an interface and an electrical component. The electrical component is electrically connected to the interface. The hub housing is mounted rotatably relative to the hub element about a rotational axis in order to rotate together with a wheel of a bicycle during operation. The interface is arranged on an outer side of the bicycle hub and is rigidly connected to the hub element. The interface is offset radially outwards relative to the rotational axis. Furthermore, the interface is configured for an electrical and mechanical coupling of the bicycle hub with a coupling element in such a way that, on the one hand, an electrical connection from the coupling element to the electrical component is established via the coupling and, on the other hand, a relative rotation between the hub element and the coupling element is blocked via the coupling.

Embodiments are based, inter alia, on the realization that a bicycle hub with an electrical component, for example an electric motor, requires an electrical connection on the one hand and a torque support connected to the bicycle hub on the other hand. The inventors had the idea of realizing a functional combination of electrical connection and torque support. In order to prevent the forces on the interface from becoming too great during torque transmission, the interface is arranged radially away from the rotational axis. The bicycle hub can then be electrically and mechanically coupled to a suitable (external) coupling element via the interface, whereby the coupling element is immovably connected to the hub element with respect to a rotation around the rotational axis. In this way, a torque acting on the hub element can be transmitted to the coupling element. If the coupling element is then fixed to the bicycle frame of a bicycle, for example, the torque transmitted by the hub element can be transferred to the bicycle frame via the coupling element.

Such a bicycle hub also allows the bicycle hub to be easily mounted on a bicycle frame, for example in combination with a slide-in shaft. Simple electrical connection of the electrical component during assembly is also possible. Due to the robust design of the interface, which is rigidly connected to the hub element, the appropriately designed coupling element can also be used as a torque support. The interface is protected against mechanical damage by its positioning and coupling with the coupling element. The interface also forms a robust electrical connection point on the bicycle hub and is protected against mechanical damage. In particular, the fact that the interface is rigidly connected to the hub element and is not realized as the movable end of a cable hanging out of the bicycle hub reduces the risk of damage to the electrical connection to the electrical component during assembly and disassembly. With the help of the interface, which in this case fulfills a dual function, torque support in the complicated and sensitive area of the hub shaft is avoided.

The hub element and the hub housing are each robust components, for example made of metal and/or plastic. The hub element is, for example, rigidly connected to a hub shaft of the bicycle hub or at least immovably connected/coupled to the hub shaft in the rotational direction. The hub element can be a part of the hub shaft, for example formed in one piece with the hub shaft, or it can be a separate element from the hub shaft. The hub element can be formed in one piece. For example, the hub element forms a wall that at least partially covers the electrical component when viewed in the axial direction. In particular, the radius of the hub element is larger than the mean radius of the hub shaft. The radius of the hub element is, for example, at least 50% or at least 75% of the maximum radius of the hub housing.

Here and in the following, an axial direction is understood to be a direction parallel to the rotational axis. Radial directions are correspondingly directions perpendicular to the rotational axis that intersect the rotational axis. An azimuthal direction or rotational direction is a direction perpendicular to the radial direction and the axial direction.

The hub housing is mounted rotatably relative to the hub element about the rotational axis, in particular about the hub shaft. In the present case, the rotational axis is understood to be the geometric or mathematical axis about which the hub housing rotates relative to the hub element and/or the hub shaft. The hub shaft is the mechanical component that is set up for a rigid connection to the frame of the bicycle. For example, the hub housing completely surrounds the electrical component radially. In particular, the electrical component can be completely covered by the hub housing when viewed radially inwards.

To enable the hub housing to rotate relative to the hub element, the bicycle hub has one or more roller bearings, for example. At least one roller bearing can be realized between the hub housing and the hub element. For example, the hub element and the hub housing then form the inner ring and outer ring of this roller bearing. Furthermore, the bicycle hub can have one or more freewheels and/or a mount for a gear rim.

The hub housing is configured to rotate together with a wheel of the bicycle during operation. For example, the hub housing has connection points for the connection with spokes of the bicycle, for example spoke flanges. In particular, the hub housing is designed to be rigidly connected to the (rear) wheel of the bicycle.

The electrical component is electrically connected to the interface. For example, a cable is routed from the interface to the electrical component. The cable can be completely surrounded radially by the hub housing. The electrical component and/or the cable cannot be seen from outside the bicycle hub, for example.

The interface is located on an outer side of the bicycle hub and is rigidly connected to the hub element. This means that the interface is immovable relative to the hub element. For example, the interface is arranged on the hub element or integrated into the hub element. In the unmounted state of the bicycle hub, the interface is preferably freely accessible from outside the bicycle hub.

The interface is offset radially outwards relative to the rotational axis. For example, a center, in particular a geometric center, of the interface or the point of the interface closest to the rotational axis is at least 2 cm or at least 3 cm or at least 4 cm away from the rotational axis in the radial direction.

The bicycle hub can be coupled at the interface with a (external) coupling element that matches the interface. The interface is configured for both electrical and mechanical coupling with the coupling element. When the coupling between the external coupling element and the bicycle hub is established via the interface, the coupling element is coupled/connected immovably to the interface or the hub element, at least with respect to a movement along the rotational direction. This means that when the coupling is established, relative rotation between the coupling element and the interface or the hub element is blocked. As a result, a torque acting on the hub element can be transmitted to the external coupling element via the interface.

“Blocked” means that free rotation is blocked. A small, relative movement due to play is possible. For example, the mechanical coupling between the coupling element and the bicycle hub is a form-fitting and/or force-fitting connection, such as a plug-in connection. This connection can block the relative rotation, but usually has a small amount of play.

An electrical connection between the external coupling element and the electrical component is also established via the interface. The electrical connection is configured, for example, to supply power to the electrical component and/or to supply the electrical component with control signals.

The coupling between the coupling element and the bicycle hub via the interface is preferably reversible. In other words, the interface is configured for reversible coupling.

According to at least one embodiment, the interface is formed by a first plug connector. The first plug connector can be plugged-in with a second plug connector. One of the first and second plug connectors is a female plug connector and the other is a male plug connector.

The first plug connector is therefore part of the bicycle hub and in particular is rigidly connected to the hub element. The second plug connector is the external coupling element. The mechanical and electrical coupling is established by plugging the first and second plug connectors into each other.

According to at least one embodiment, the first plug connector is configured to be plugged-in with the second plug connector in axial direction, i.e. in a direction parallel to the rotational axis. In other words, during plugging, the two plug connectors are moved relative to each other in an axial direction, for example exclusively in an axial direction.

According to at least one embodiment, the first plug connector is a socket in the bicycle hub, for example in the hub element. The interface is then formed, for example, by an exposed end of the socket. Alternatively, the first plug connector could also be a built-in plug in the bicycle hub, for example in the hub element. In this case, the interface would also be formed by the exposed end of the plug connector.

However, the interface can also be realized in another way than by a plug connector. For example, the interface could be an interface for contactless electrical and mechanical coupling to the coupling element. The interface could be configured for mechanical coupling by electromagnetic interaction. In particular, the interface could be the interaction region of a magnet of the bicycle hub. If the coupling element also has a magnet, mechanical coupling could be achieved by magnetic interaction.

The interface could also be a fiber optic interface for the transmission of optical signals. For example, optical signals for controlling the electrical component can be transmitted via the interface.

According to at least one embodiment, the electrical component is an electric motor that is configured to rotate the hub housing relative to the hub element. In particular, the electric motor is surrounded by the hub housing and cannot be seen from outside the bicycle hub, for example. A rotor of the electric motor can be rigidly connected to the hub housing and a stator of the electric motor can be rigidly connected to the hub element. During operation of the electric motor, in addition to the torque transmitted to the hub housing, an (undesired) torque is transmitted to the hub element, which is then transmitted to the coupling element coupled to the interface, for example.

The bicycle hub may further comprise a gearbox, such as a planetary gearbox, to transmit the torque generated by the electric motor to the hub housing.

According to at least one embodiment, the interface is arranged on an outer surface of the bicycle hub directed in an axial direction. For example, the hub element forms a circular or annular outer surface of the bicycle hub. A normal to this outer surface runs parallel or essentially parallel, for example at an acute angle of no more than 30°, to the rotational axis. The interface can be arranged on this outer surface.

Further embodiments provide the system. For example, the system is part of a bicycle or is intended to be assembled with other bicycle components to form a bicycle.

In at least one embodiment, the system comprises a bicycle hub according to one of the embodiments described herein, a frame element and a coupling element. The bicycle hub is mechanically coupled to the frame element in such a way that the hub housing can be rotated relative to the frame element and relative to the hub element about the rotational axis. The coupling element is electrically and mechanically coupled to the bicycle hub via the interface. The coupling element is also mechanically coupled to the frame element. An electrical connection from the coupling element to the electrical component is established with the help of the electrical coupling between the coupling element and the bicycle hub established via the interface. In addition, a torque support for the bicycle hub is realized with the help of the mechanical coupling between the coupling element and the bicycle hub established via the interface and with the help of the mechanical coupling between the coupling element and the frame element.

Since the system comprises a bicycle hub according to one of the embodiments described herein, all features disclosed in connection with the bicycle hub are also disclosed for the system and vice versa. In particular, the coupling element of the system is the (external) coupling element described in connection with the bicycle hub.

The mechanical coupling between the bicycle hub and the frame element, which enables the hub housing to rotate, is a separate mechanical coupling that is not generated via the interface or the coupling element. The coupling between the bicycle hub and the frame element is, for example, a direct connection between the hub shaft and the frame element. In particular, the hub shaft and/or the hub element can be rigidly connected to the frame element.

The frame element can be the bicycle frame or the frame element can be part of a bicycle frame or a part for a bicycle frame.

The mechanical coupling between the coupling element and the bicycle hub and/or the mechanical coupling between the coupling element and the frame element are, for example, each a form-fitting and/or a force-fitting connection. For example, the coupling element engages in the frame element and/or in the bicycle hub.

Due to the mechanical coupling between the coupling element and the bicycle hub, a torque acting on the hub element during operation is transmitted to the coupling element. The mechanical coupling between the coupling element and the frame element then transfers the torque from the coupling element to the frame element so that, as a result, the torque is transferred to the frame element.

In other words, the coupling element transmits the torque from the bicycle hub to the frame element and thus acts as a torque transmission element. The coupling element is correspondingly stable or rigid in order to transmit the torque. Apart from the coupling element, for example, no other torque support is used to transfer the torque to the frame element.

The mechanical coupling between the coupling element and the bicycle hub produced via the interface together with the coupling between the coupling element and the frame element is preferably designed in such a way that the bicycle hub is held in position relative to the frame element even if the (separate) mechanical coupling between the bicycle hub and the frame element is released. This means that the mechanical coupling between the bicycle hub and the frame element established via the coupling element is strong enough to hold the bicycle hub in position even then.

According to at least one embodiment, the coupling element is a plug connector and the mechanical and electrical coupling between the coupling element and the bicycle hub is a plug connection.

According to at least one embodiment, a plug housing extends contiguously between the frame element and the bicycle hub and projects at least into both the frame element and the bicycle hub. The plug housing can be part of the coupling element or part of the bicycle hub.

According to at least one embodiment, the plug housing surrounds electrical conductors of the electrical connection. For example, the plug housing surrounds a plug contact and/or a socket contact of the electrical connection.

According to at least one embodiment, the plug housing is formed stable enough to divert at least part of the torque acting on the hub element during operation of the bicycle hub to the frame element. This means that the plug housing withstands the forces that occur when the torque is diverted and does not deform, for example, or only slightly and then in particular reversibly, when the torque is transmitted. For example, the plug housing is stable enough to divert the entire torque acting on the hub element to the frame element.

According to at least one embodiment, the plug housing is made of hard plastic and/or metal.

According to at least one embodiment, the coupling element is a plug. The plug housing is then, for example, the housing of the plug.

According to at least one embodiment, the plug is an angled plug.

According to at least one embodiment, the coupling element is guided through a hole in the frame element. A side wall of the frame element bounding the hole forms a stop for the coupling element, with the help of which the torque support is realized. In particular, the side wall therefore limits the hole in the rotational direction. When the torque is transmitted to the coupling element, rotation of the coupling element about the rotational axis is blocked by striking against the side wall of the hole.

According to at least one embodiment, the interface overlaps with the hole when viewed in a direction parallel to the rotational axis. This means that when the coupling element is not guided through the hole, the interface is at least partially visible or accessible through the hole in this viewing direction. In the described viewing direction, the hole is, for example, round, in particular circular.

According to at least one embodiment, the coupling element is accommodated in a recess in the frame element. A side wall of the frame element bounding the recess forms a stop for the coupling element, with the help of which the torque support is realized. In contrast to the hole, the recess is not laterally completely surrounded by the frame element. Such a recess can be realized particularly easily without affecting the stability of the frame element. In addition, the recess is also preferably formed in such a way that the coupling element absorbing the torque is prevented from rotating about the rotational axis by striking against the side wall delimiting the recess.

According to at least one embodiment, the recess overlaps with the interface when viewed in a direction parallel to the rotational axis. This means that when the coupling element is not mounted, the interface is at least partially visible or accessible in the area of the recess in this viewing direction. In the described viewing direction, the recess is, for example, quadrangular, in particular oblique parallelogram-shaped. For example, the frame element forms three sides of the quadrangular recess and the recess is open on the fourth side, for example open at the bottom.

According to at least one embodiment, the coupling element is arranged at one end of a cable. For example, the coupling element is electrically connected to a battery or an accumulator and/or a control unit via the cable.

According to at least one embodiment, the cable runs at least in sections inside the frame element. In particular, the frame element can be formed as a hollow body. The cable then runs, for example, in a tunnel-shaped section of the frame element, for example along a longitudinal extension direction of the tunnel-shaped section.

According to at least one embodiment, starting from the coupling element, the cable initially runs outside the frame element, is then guided through an opening in the frame element into the interior of the frame element and from thereon runs at least in sections inside the frame element. For example, the transition point at which the cable merges into the coupling element is located on a side of the frame element opposite the bicycle hub. This means that the frame element is arranged in a direction parallel to the rotational axis between the transition point and the bicycle hub. The opening for the cable is, for example, a separate opening from the hole or recess for the coupling element. The opening can be at a distance from the hole/recess.

Yet other embodiments provide a bicycle. The bicycle is in particular an electric bicycle, for example a so-called pedelec.

In at least one embodiment, the bicycle comprises a system according to one of the embodiments described herein. Consequently, all features disclosed in connection with the system are also disclosed for the bicycle and vice versa. For example, the bicycle hub forms a rear wheel hub drive.

According to at least one embodiment, the bicycle comprises a control unit and/or an accumulator which is electrically connected to the bicycle hub via the coupling between the coupling element and the bicycle hub established at the interface.

The control unit can be used, for example, to transmit control signals to the electrical component in the bicycle hub, such as motor control signals.

Next, the method for mounting a bicycle hub is described. The method can be used, for example, to manufacture the system described herein. All features disclosed in connection with the system are therefore also disclosed for the method and vice versa.

In at least one embodiment, a bicycle hub according to one of the embodiments described herein is provided for the method. In addition, a frame element and a coupling element are provided. In a next step, the bicycle hub is mechanically coupled to the frame element such that the hub housing is rotatable relative to the frame element and relative to the hub element about the rotational axis. Furthermore, the coupling element is electrically and mechanically coupled to the bicycle hub via the interface. Furthermore, the coupling element is mechanically coupled to the frame element. The electrical coupling between the coupling element and the bicycle hub established via the interface is used to establish an electrical connection from the coupling element to the electrical component, and the mechanical coupling between the coupling element and the bicycle hub established via the interface and the mechanical coupling between the coupling element and the frame element are used to create a torque support for the bicycle hub.

The mechanical coupling between the coupling element and the frame element is created, for example, by bringing the coupling element into form-fitting engagement with the frame element. For example, the coupling element is pushed through the hole or recess in the frame element from a side of the frame element facing away from the bicycle hub and then coupled to the bicycle hub via the interface. Coupling between the coupling element and the bicycle hub can also be achieved by bringing the coupling element into form-fitting engagement with the bicycle hub at the interface.

The step of mechanically coupling the bicycle hub to the frame element can take place before or after coupling the bicycle hub to the coupling element. For example, the bicycle hub is bolted to the frame element or connected using a quick-release axle. Alternatively, the coupling can also be made via a slide-in shaft.

The step of coupling the coupling element to the frame element takes place simultaneously with the step of coupling the coupling element to the bicycle hub, for example.

In the following, a bicycle hub described herein, a system described herein, a bicycle described herein and a method for mounting a bicycle hub described herein are explained in more detail with reference to drawings using exemplary embodiments. Identical reference signs indicate identical elements in the individual figures. However, references are not necessarily shown to scale; rather, individual elements may be shown in exaggerated size for better understanding. Insofar as elements or components in the various figures correspond in their function, their description is not repeated for each of the following figures. For reasons of clarity, elements may not be provided with corresponding reference signs in all figures.

### BRIEF DESCRIPTION OF THE DRAWINGS

FIG. 1 shows an exemplary embodiment of a bicycle;

FIG. 2 shows an exemplary embodiment of a bicycle hub in side view and cross-sectional view;

FIGS. 3 to 6 show different positions in an exemplary embodiment of the method for mounting a bicycle hub;

FIGS. 7 and 8 show different positions in a further exemplary embodiment of the method for mounting a bicycle hub;

FIG. 9 shows an exemplary embodiment of a coupling element; and

FIG. 10 shows a cross-sectional view of an exemplary embodiment of the system.

### DETAILED DESCRIPTION OF ILLUSTRATIVE EMBODIMENTS

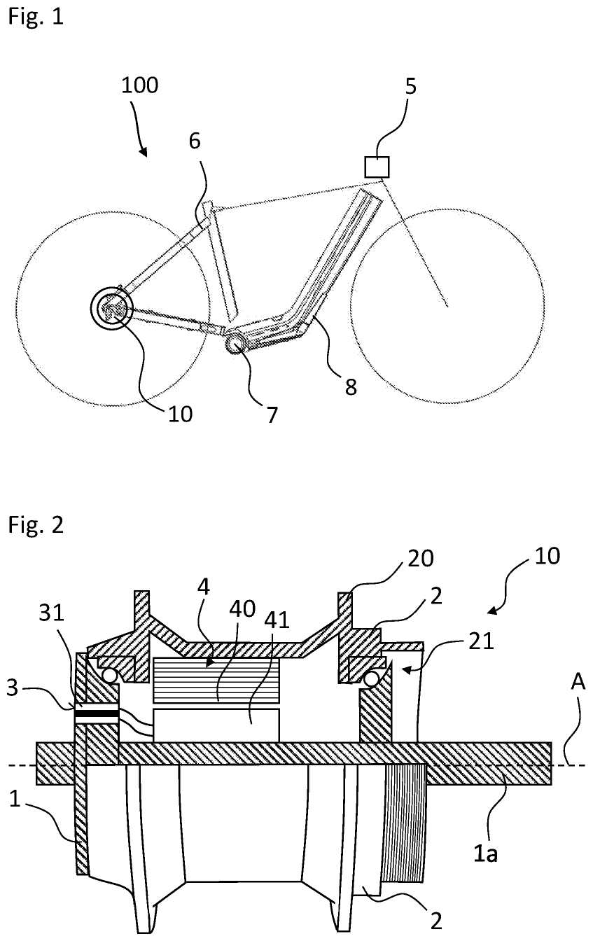

FIG. 1 schematically shows an electric bicycle 100 with a bicycle frame 6, which extends in the direction of a bottom bracket 7 and in the direction of a rear bicycle hub 10. The bicycle hub 10 is electrically connected to a control unit 5 and an accumulator 8.

Terms such as “front”, “rear”, “top”, “bottom”, “right”, “left”, “outside” and “inside” refer to alignments or orientations of respective components as illustrated in the figures and as they are arranged in an operational state of the electric bicycle 100. The electric bicycle 100 generally has a front wheel and a rear wheel. An outer area refers to an area outside the electric bicycle 100.

In FIG. 2, the bicycle hub 10 of FIG. 1 is shown in a two-part view, whereby a side view of the bicycle hub 10 is shown below the rotational axis A and a cross-sectional view is shown above the rotational axis A.

The bicycle hub 10 comprises a hub shaft 1a, a hub element 1 and a hub housing 2. The hub element 1 in the present case forms a wall which, together with the hub housing 2, surrounds an interior in which an electrical component 4 in the form of an electric motor 4 is arranged.

The hub shaft 1a, the hub element 1 and the hub housing 2 are each made of metal, for example. The hub element 1 is rigidly connected to the hub shaft 1a, for example welded to the hub shaft 1a or formed in one piece with it.

The hub element 1 forms an outer surface of the bicycle hub 10 pointing in an axial direction, parallel to the rotational axis A, on which an interface 3 for mechanical and electrical coupling to an external coupling element is arranged. The interface 3 is rigidly connected to the hub element 1.

The hub housing 2 is arranged rotatable about the rotational axis A and relative to the hub element 1. Roller bearings 21 are provided in the bicycle hub 10 for this purpose. The hub housing 2 is coupled here, for example, to a rotor 40 of the electric motor 4 and the hub shaft 1a is coupled to a stator 41 of the electric motor 4. A gearbox (not shown) can be connected between the hub housing 2 and the electric motor 4.

During operation of the electric motor 4, the rotor 40 rotates relative to the stator 41 about the rotational axis A and thereby drives the hub housing 2 to rotate about the rotational axis A or about the hub shaft 1a. The hub housing 2 comprises spoke flanges 20 for connection to spokes of a wheel so that, during operation, the hub housing 2 rotates together with the rear wheel of the electric bicycle 100.

In the present exemplary embodiment, the interface 3 is formed by a plug connector 31 in the form of a socket, which is integrated or embedded in the hub element 1. The interface 3 is electrically connected to the electric motor 4. For example, electrical control signals for controlling or electrical current for supplying power to the electric motor 4 are transmitted to the bicycle hub 10 via the interface 3.

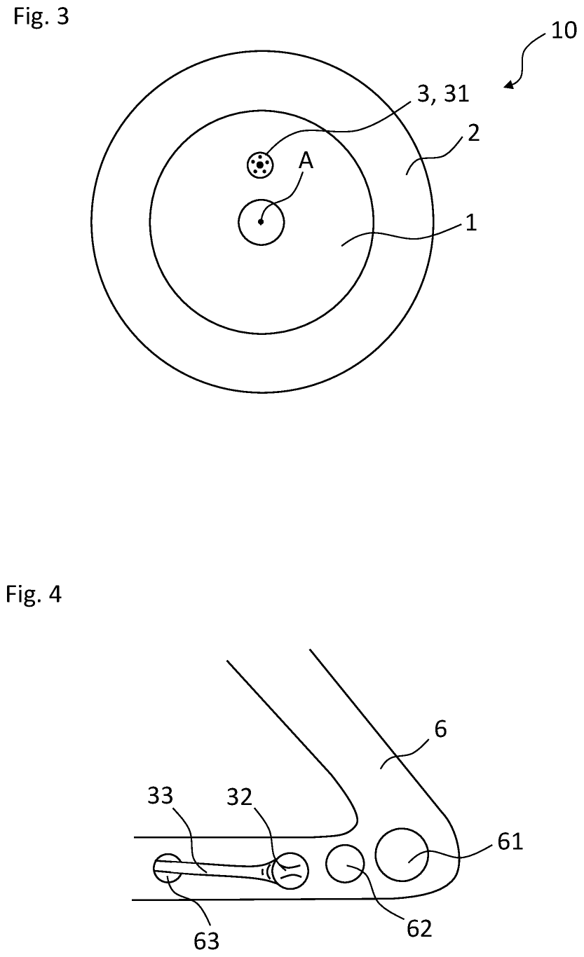

FIG. 3 shows a first position in an exemplary embodiment of the method for mounting a bicycle hub. Here, the bicycle hub 10 of FIG. 2 is provided and shown in a side view when viewed along the rotational axis A. As can be clearly seen, the interface 3 or the socket 31 is offset radially outwards with respect to the rotational axis A, for example by at least 3 cm.

FIG. 4 shows a further position in which a frame element 6, in this case the rear part of the bicycle frame 6 of FIG. 1, is provided. In the rear section of the frame element 6, a through hole 61 is provided for receiving the hub shaft 1a of the bicycle hub 10. A hole 62 is provided somewhat further forward in the frame element 6. The hole 62 passes completely through the frame element 6 in the axial direction. Still further forward, an opening 63 is provided in the frame element 6. The opening 63 forms an access to an inner, tunnel-shaped area of the frame element 6. A cable 33 protrudes from the opening 63. The cable 33 is guided in sections in the inner, tunnel-shaped area of the frame element 6. A plug connector 32 in the form of a plug 32 is provided at one end of the part of the cable 33 protruding from the frame element 6.

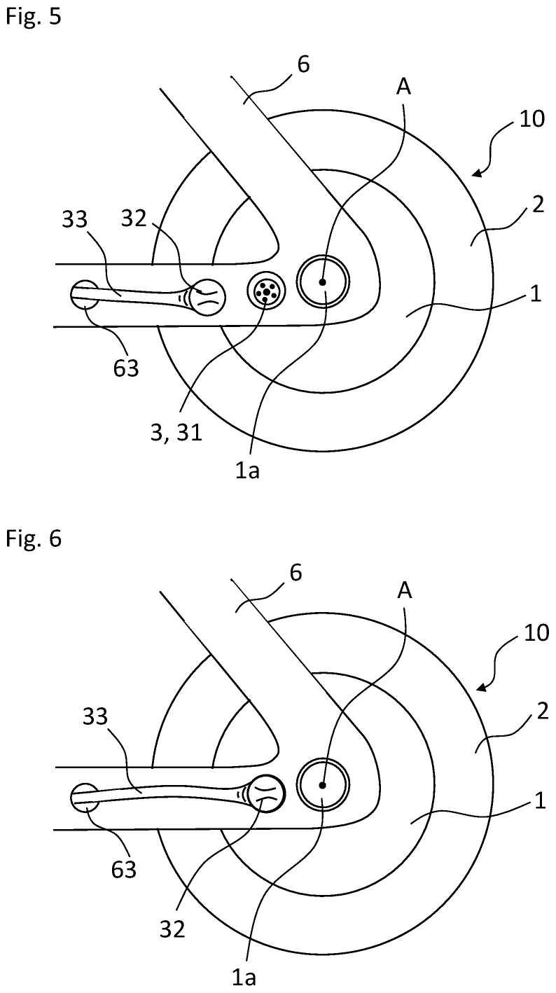

FIG. 5 shows a position in the method in which the bicycle hub 10 of FIGS. 2 and 3 is mechanically coupled to the frame element 6, in that the hub shaft 1a is guided through the through hole 61 and rigidly connected to the frame element 6. It can also be seen that the bicycle hub 10 is aligned in such a way that, in the illustrated viewing direction parallel to the rotational axis A, the interface 3 of the bicycle hub 10 overlaps with the hole 62 in the frame element 6. The interface 3 is visible through the hole 62 and accessible via the hole 62.

FIG. 6 shows a position in which the plug 32 is guided through the hole 62 and inserted into the interface 3 or into the socket 31. The plug 32 and the bicycle hub 10 are therefore coupled to each other both electrically and mechanically via the interface 3. The form-fitting engagement of the plug 32 in the hole 62 of the frame element 6 also creates a mechanical coupling between the plug 32 and the frame element 6.

When the bicycle hub 10 is driven by the electric motor 4, a torque is exerted on the hub housing 2, which causes the hub housing 2 to rotate about the rotational axis A. At the same time, however, a torque is also exerted on the hub shaft 1a and thus on the hub element 1. This torque is transmitted to the plug 32 via the mechanical coupling between the plug 32 and the bicycle hub 10. The plug 32 is prevented from rotating about the rotational axis A by the engagement in the hole 62 in the frame element 6. Since the plug 32 is stable and rigid, a torque support for the bicycle hub 10 is realized with the help of the plug 32.

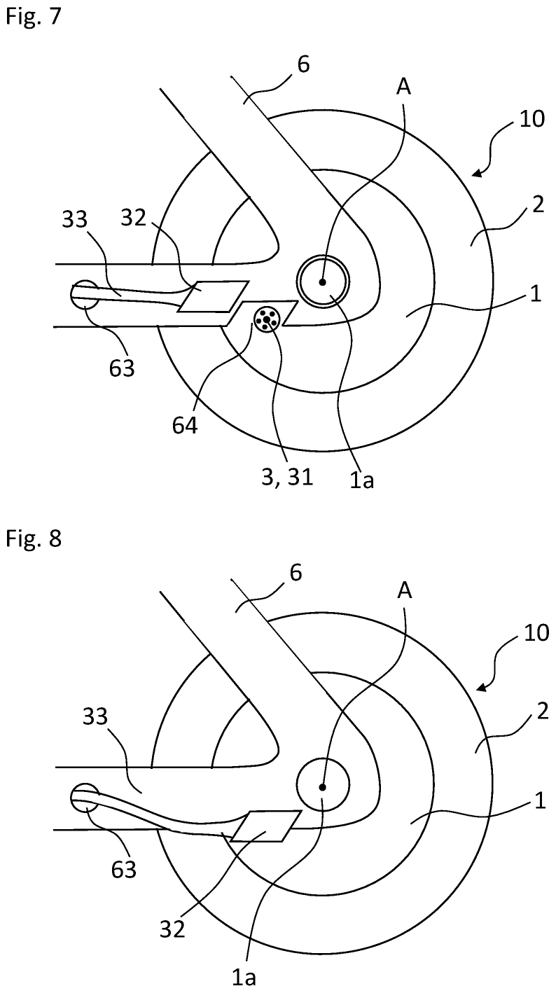

FIG. 7 shows a position in a further exemplary embodiment of the method for mounting a bicycle hub 10. Unlike in FIG. 5, no hole 62 is provided here in the frame element 6 for the guiding through of a plug, but rather a recess 64. The recess 64 is arranged at the lower part of the frame element 6 and has an oblique parallelogram-shaped cross-section in the plan view shown. Similarly, the plug 32 has an oblique parallelogram-shaped cross-section in the plan view for form-fitting engagement in the recess 64.

If, as shown in FIG. 8, the plug 32 is accommodated in the recess 64 and inserted into the socket 31 of the bicycle hub 10, a torque exerted on the hub element 1 is transmitted to the plug 32 during operation of the electric motor 4. This transfers the torque to the frame element 6 through the form-fitting engagement in the recess 64. In particular, the recess 64 and the plug 32 are matched to one another in such a way that, when they engage with one another, rotation of the plug 32 about the rotational axis A relative to the frame element 6 is blocked.

FIG. 9 shows a side view of an exemplary embodiment of the coupling element 32. It is a plug 32, for example the one shown in FIGS. 5 and 6. The plug 32 is an angled plug.

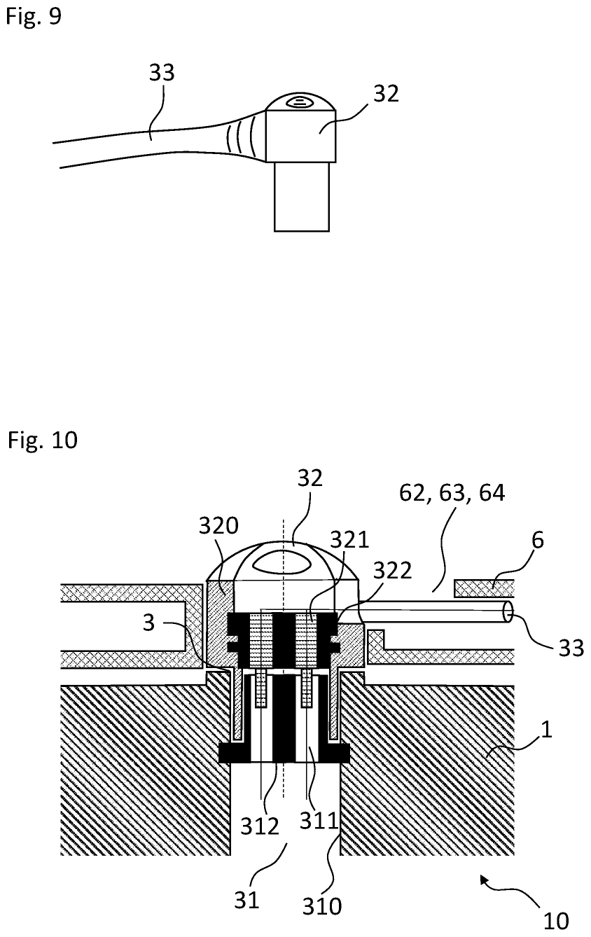

FIG. 10 shows an exemplary embodiment of the system in which the plug 32 of FIG. 9 is guided through a hole 62 or a recess 64 in the frame element 6 and is mechanically and electrically coupled to the bicycle hub 10 via the interface 3.

The interface 3 of the bicycle hub 10 is again formed here by a socket 31 of the bicycle hub 10. The socket housing 310 is formed by the hub element 1. The socket housing 310 surrounds the socket contact 311 and the socket insert 312 of the socket 31.

The plug 32 has a plug contact 321 and a plug insert 322. The plug contact 321 and the plug insert 322 are surrounded by a plug housing 320. The plug housing 320 is formed stable, for example from metal or hard plastic.

The plug housing 320 is plugged into the socket 31. The plug contact 321 is plugged into the socket contact 311, thereby establishing the electrical connection. The plug housing 320 extends contiguously from the frame element 6 into the hub element 1 and projects into both the frame element 6 and the hub element 1.

During operation of the bicycle hub 10, the torque exerted on the hub element 1 is then predominantly transmitted to the frame element 6 via the stable plug housing 320.

The invention is not limited to the description based on the exemplary embodiments. Rather, the invention includes any new feature as well as any combination of features, which includes in particular any combination of features in the claims, even if these features or this combination itself is not explicitly stated in the claims or exemplary embodiments.

What is claimed is:

1. A bicycle hub comprising:
a hub element;
a hub housing;
an interface; and
an electrical component electrically connected to the interface,
wherein the hub housing is mounted rotatably relative to the hub element about a rotational axis in order to rotate together with a wheel of a bicycle,
wherein the interface is arranged on an outer side of the bicycle hub and is rigidly connected to the hub element,
wherein the interface is offset radially outwards relative to the rotational axis, and
wherein the interface is configured for an electrical and mechanical coupling of the bicycle hub to a coupling element such that an electrical connection from the coupling element to the electrical component is established via the coupling and relative rotation between the hub element and the coupling element is blocked via the coupling.

2. The bicycle hub according to claim 1,
wherein the interface is formed by a first plug connector pluggable to a second plug connector,
wherein the first plug connector is configured to be plugged-in with the second plug connector in a direction parallel to the rotational axis.

3. The bicycle hub according to claim 2, wherein the first plug connector is a socket in the bicycle hub.

4. The bicycle hub according to claim 1,
wherein the electrical component is an electric motor (configured to rotate the hub housing relative to the hub element, and
wherein the electric motor is surrounded by the hub housing.

5. The bicycle hub according to claim 1, wherein the interface is arranged on an outer surface of the bicycle hub directed in an axial direction, the axial direction being a direction parallel to the rotational axis.

6. A system, comprising:
the bicycle hub according to claim 1;
a frame element;
the coupling element,
wherein the bicycle hub is mechanically coupled to the frame element such that the hub housing is rotatable relative to the frame element and relative to the hub element about the rotational axis,
wherein the coupling element is electrically and mechanically coupled to the bicycle hub via the interface,
wherein the coupling element is mechanically coupled to the frame element;
the electrical connection established from the coupling element to the electrical component with help of an electrical coupling between the coupling element and the bicycle hub established via the interface; and
a torque support for the bicycle hub realized with help of a mechanical coupling between the coupling element and the bicycle hub via the interface and with help of a mechanical coupling between the coupling element and the frame element.

7. The system according to claim 6,
wherein the coupling element is a plug connector and the mechanical and electrical coupling between the coupling element and the bicycle hub is a plug connection,
wherein a plug housing extends contiguously between the frame element and the bicycle hub and projects at least into both the frame element and the bicycle hub,
wherein the plug housing surrounds electrical conductors of the electrical connection, and
wherein the plug housing is formed stable enough to divert at least a part of the torque acting on the hub element of the bicycle hub to the frame element.

8. The system according to claim 7, wherein the plug housing is formed of a hard plastic and/or metal.

9. The system according to claim 7,
wherein the coupling element is a plug, and
wherein the plug housing is the housing of the plug.

10. The system according to claim 9, wherein the plug is an angled plug.

11. The system according to claim 6,
wherein the coupling element is guided through a hole in the frame element, wherein a side wall of the frame element bounding the hole forms a stop for the coupling element, with help of which the torque support is realized, and
wherein the hole overlaps with the interface when viewed in a direction parallel to the rotational axis.

12. The system according to claim 6,
wherein the coupling element is accommodated in a recess of the frame element, wherein a side wall of the frame element bounding the recess forms a stop for the coupling element with help of which the torque support is realized, and
wherein the recess overlaps with the interface when viewed in a direction parallel to the rotational axis.

13. The system according to claim 6,
wherein the coupling element is arranged at one end of a cable, and
wherein the cable runs at least in sections inside the frame element.

14. The system according to claim 13,
wherein the cable, starting from the coupling element, initially runs outside the frame element, is then guided through an opening in the frame element into an interior of the frame element and from thereon runs at least in sections inside the frame element.

15. The bicycle comprising:
the system according to claim 6; and
a control unit and/or an accumulator electrically connected to the bicycle hub via the coupling between the coupling element and the bicycle hub established at the interface.

16. A method comprising:
providing bicycle hub, a frame element and a coupling element, the bicycle hub comprising a hub element, a hub housing, an interface and an electrical component;
mechanically coupling of the bicycle hub to the frame element such that the hub housing is rotatable relative to the frame element and relative to the hub element about a rotational axis;
electrically and mechanically coupling the coupling element to the bicycle hub via the interface; and
mechanically coupling the coupling element to the frame element, wherein an electrical connection between the coupling element and the electrical component is established with help of the electrical coupling established between the coupling element and the bicycle hub via the interface, and
wherein a torque support for the bicycle hub is realized with help of the mechanical coupling established between the coupling element and the bicycle hub via the interface and with help of the mechanical coupling between the coupling element and the frame element.
